(19) United States
(12) Patent Application Publication
(10) Pub. No.: US 2014/0356772 A1
(43) Pub. Date: Dec. 4, 2014

(54) TERPENE POLYCARBONATE CONTAINING PHOTOCONDUCTORS

(71) Applicant: Jin Wu, Pittsford, NY (US)

(72) Inventor: Jin Wu, Pittsford, NY (US)

(73) Assignee: Xerox Corporation, Norwalk, CT (US)

(21) Appl. No.: 13/909,005

(22) Filed: Jun. 3, 2013

(51) Int. Cl. G03G 5/05

(52) U.S. Cl. CPC G03G 5/0564
USPC 430/59.6; 430/96; 430/78; 430/71; 430/64

(57) ABSTRACT

A photoconductor that includes, for example, a supporting substrate, an optional ground plane layer, an optional hole blocking layer, an optional adhesive layer, a photogenerating layer, and a charge transport layer, and where the charge transport layer contains a mixture of a charge transport component and a bio-based polycarbonate.

Disclosed herein are photoconductors comprised of a photogenerating layer and a charge transport layer comprised of a mixture of a charge transport component and biodegradable or bio-based terpene polycarbonates.

### BACKGROUND

A vast number of polycarbonate resins are known inclusive of where certain photoconductor polycarbonates are selected as resin binders. These polycarbonates are considered petroleum-based polymers synthesized via traditional interfacial phosgenation processes, and where the toxic reactant phosgene is selected.

The environmental issues relating to the use of toxic chemicals has been well documented, especially as these chemicals adversely affect human beings, animals, trees, plants, fish, and other resources. Also, it is known that toxic chemicals usually cannot be safely recycled, are costly to prepare, cause the pollution of the world's water, add to the carbon footprint, and reduce the oil and coal reserves. Thus, there has been an emphasis on the development of green materials, such as bio based polymers, that minimize the economic impacts and uncertainty associated with the reliance on petroleum imported from unstable regions.

Biodegradable (bio) substances have been referred to as a group of materials that respond to the action of enzymes or from chemical degradation associated with interaction with living organisms. Biodegradation may also occur through chemical reactions that are initiated by photochemical processes, oxidation and hydrolysis that result from the action of environmental factors. Also, biodegradation of substances is not limited to naturally occurring materials but includes some synthetic substances that possess chemical functionalities found in natural compounds. However, these polymers can be costly to prepare, may not fully be biodegradable, and may decompose resulting in emitting carbon or carbon products to the environment.

Photoconductors that include certain photogenerating layers and specific charge transport layers are known. While these photoconductors may be useful for xerographic imaging and printing systems, many of them have a tendency to deteriorate, and thus have to be replaced at considerable costs and with extensive resources. A number of known photoconductors also have a minimum of, or lack of, resistance to abrasion from dust, charging rolls, toner, and carrier. For example, the surface layers of photoconductors are subject to scratches, which decrease their lifetime, and in xerographic imaging systems adversely affect the quality of the developed images. While used photoconductor components can be partially recycled, there continues to be added costs and potential environmental hazards when recycling.

Therefore, there is a need for photoconductors that contain bio-based polymers that minimize or substantially eliminate the disadvantages illustrated herein.

Also, there is a need for polymers derived from sources other than petroleum.

Yet another need resides in the provision of polycarbonate resin binders that can be prepared without the use of the toxic reactant phosgene.

Further, there is a need for economical processes for the preparation of biodegradable or bio-based polycarbonate resins that can be selected for incorporation into photoconductor charge transport layers.

Another need relates to the provision of photoconductors which are believed to simultaneously exhibit excellent photoinduced discharge and charge/discharge cycling stability characteristics (PIDC) and improved bias charge roll (BCR) wear resistance in xerographic imaging and printing systems.

Additionally, there is a need for photoconductors with extended lifetimes and reduced wearing characteristics.

There is also a need for light shock and ghost resistant photoconductors with excellent or acceptable mechanical characteristics, especially in xerographic systems where biased charging rolls (BCR) are used.

Photoconductors with excellent cyclic characteristics and stable electrical properties, stable long term cycling, minimal charge deficient spots (CDS), and acceptable lateral charge migration (LCM) characteristics are also desirable needs.

Moreover, there is a need for scratch resistant photoconductive surface layers.

These and other needs are believed to be achievable with the photoconductors disclosed herein.

### SUMMARY

There is disclosed a photoconductor comprising an optional supporting substrate, a photogenerating layer, and a charge transport layer, and wherein the charge transport layer contains a charge transport component and a biodegradable or bio-based terpene polycarbonate.

Also disclosed is a photoconductor comprised in sequence of a supporting substrate, a hole blocking layer thereover, a photogenerating layer, and a charge transport layer comprised of a mixture of an aryl amine hole transport compound, and a bio-based polycarbonate homopolymer as represented by the following formulas/structures

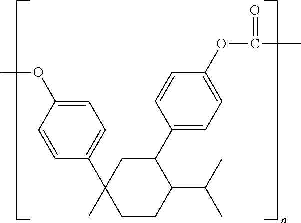

wherein n is about 100 mole percent; or a bio-based polycarbonate copolymer as represented by the following formulas/structures

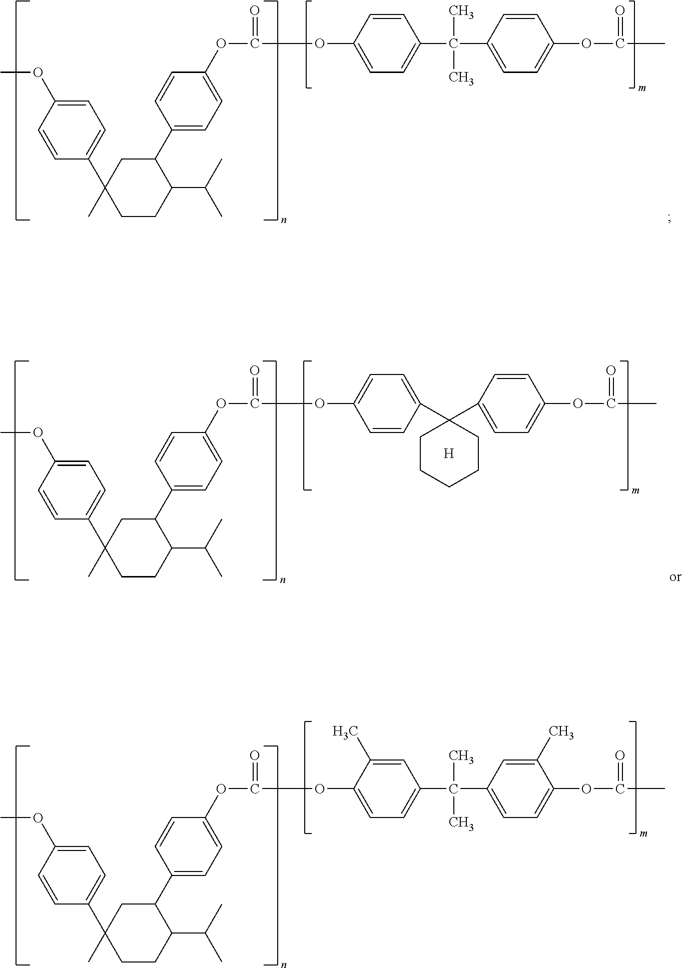

wherein m is from about 1 to about 99 mole percent, and n is from about 99 to about 1 mole percent, and the total thereof is 100 mole percent.

Further disclosed is a photoconductor comprising in sequence a supporting substrate, a hole blocking layer thereover, a photogenerating layer, and a hole transport layer comprised of a mixture of a hole transport compound and a bio-based terpene polycarbonate, and which photoconductor possesses a wear rate of from about 35 to about 65 nanometers/kilocycle.

### FIGURES

There are provided the following Figures to further illustrate the photoconductors disclosed herein.

FIG. 1 illustrates an exemplary embodiment of a layered photoconductor of the present disclosure.

FIG. 2 illustrates an exemplary embodiment of a layered photoconductor of the present disclosure.

### EMBODIMENTS

In embodiments of the present disclosure, there is illustrated a photoconductor comprising an optional supporting substrate, a photogenerating layer, and a bio-based polycarbonate containing charge transport layer. A bio-based material or biodegradable means, for example, a material generated from substances derived from living or once-living organisms or a substance that includes a bio-based component.

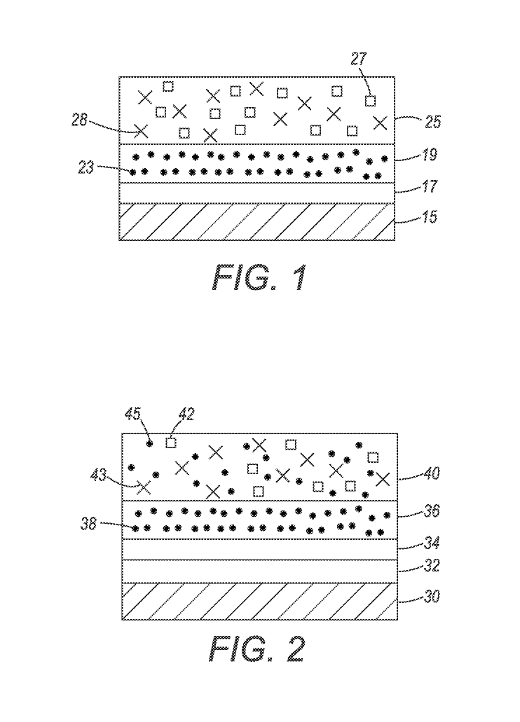

Exemplary and non-limiting examples of photoconductors according to embodiments of the present disclosure are depicted in FIGS. 1 and 2.

In FIG. 1, there is illustrated a photoconductor comprising an optional supporting substrate layer 15, an optional hole blocking layer 17, a photogenerating layer 19 containing photogenerating pigments 23, and a charge transport layer 25 containing a mixture of charge transport compounds 27, and bio-based or biodegradable terpene polycarbonates 28.

In FIG. 2, there is illustrated a photoconductor comprising an optional supporting substrate layer 30, an optional hole blocking layer 32, an optionally adhesive layer 34, a photogenerating layer 36 containing inorganic or organic photogenerating pigments 38, and a charge transport layer 40 containing charge transport compounds 42, a bio-based terpene polycarbonate homopolymer or a bio-based or biodegradable terpene copolymer first resin binder 43 and a second optional binder of a polymer 45, such as a polycarbonate.

Terpene Polycarbonates

Various environmentally acceptable and bio-based terpene polycarbonates can be selected for inclusion in the photoconductor charge transport layer or layers of the present disclosure. Examples of terpene polycarbonates, inclusive of homopolymers and copolymers thereof, selected for the disclosed charge transport layer are represented by at least one of the following formulas/structures

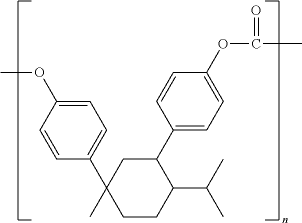

wherein n is about 100 mole percent;

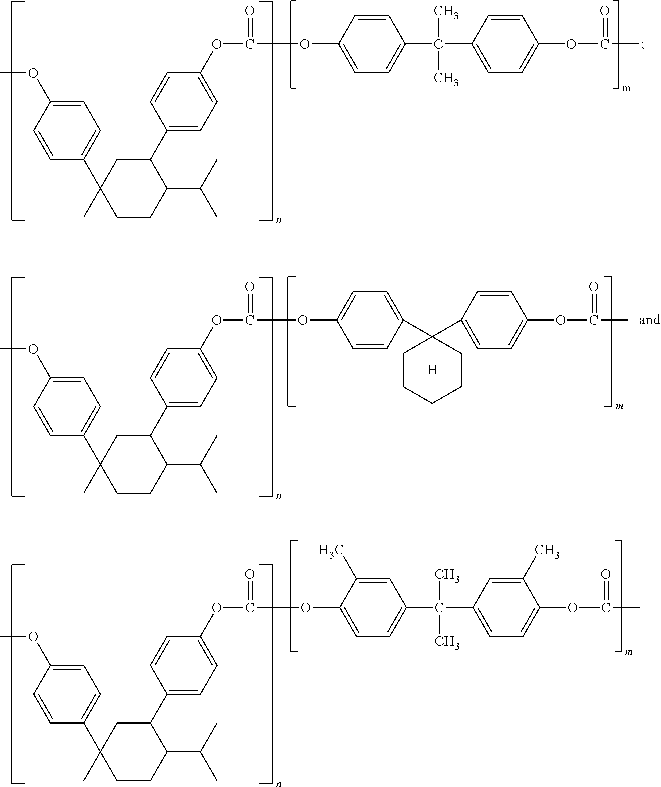

wherein m and n are the mole percents of each segment, respectively, as measured by known methods, and more specifically, by NMR, with m and n each being, for example, from about 1 to about 99 mole percent, from about 5 to about 80 mole percent, from about 20 to about 75 mole percent, from about 50 to about 95 mole percent, from about 60 to about 90 mole percent, from about 60 to about 95 mole percent, from about 70 to about 90 mole percent, or from about 65 to about 85 mole percent with the total of m and n being equal to about 100 percent. More specifically, m is from about 35 to about 75 mole percent and n is from about 25 to about 65 mole percent, m is from about 45 to about 90 mole percent and n is from about 10 to about 55 mole percent, m is from about 35 to about 85 mole percent and n is from about 15 to about 65 mole percent, and m is from about 70 to about 80 mole percent and n is from about 20 to about 30 mole percent.

Specific examples of environmentally acceptable terpene polycarbonate copolymers present as resin binders in the charge transport layer mixture are represented by the following formulas/structures wherein n is 35 mole percent and m is 65 mole percent

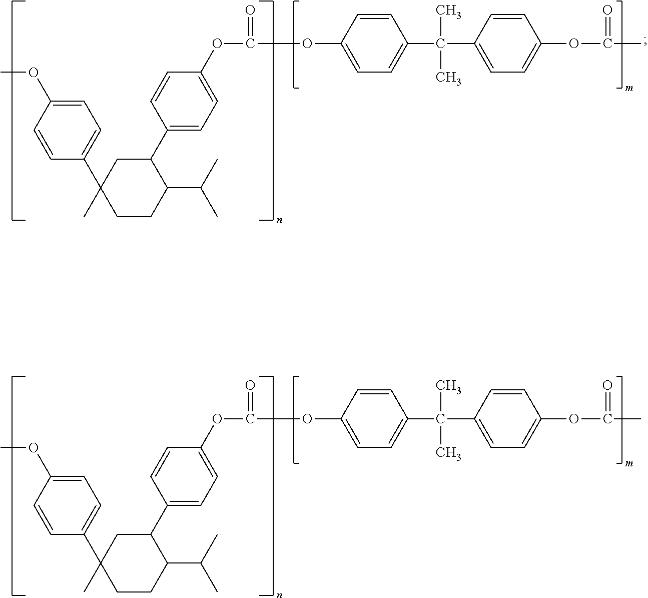

wherein n is 20 mole percent and m is 80 mole percent;

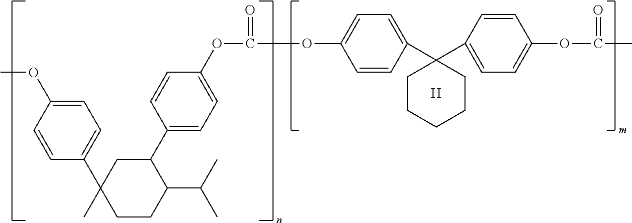

wherein n is 45 mole percent and m is 55 mole percent;

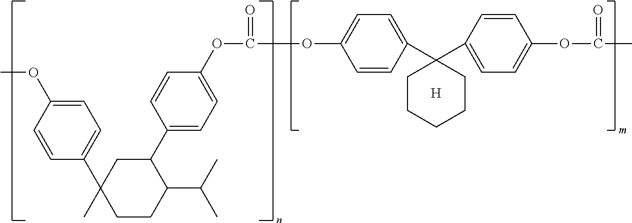

wherein n is 10 mole percent and m is 90 mole percent;

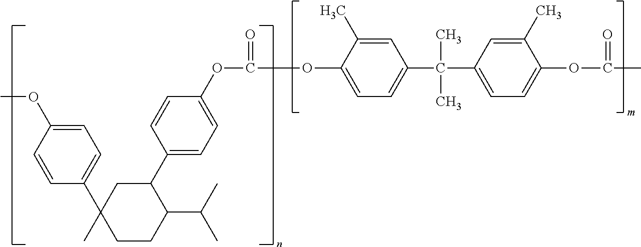

wherein n is 25 mole percent and m is 75 mole percent; and

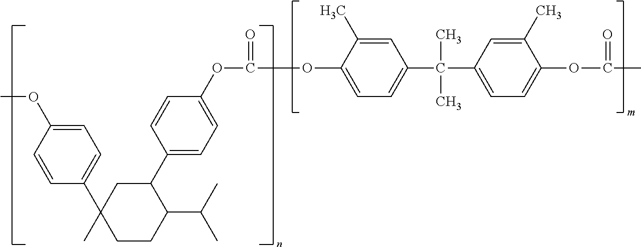

wherein n is 5 mole percent and m is 95 mole percent.

In the charge transport layer mixture, the bio-based or terpene polycarbonates illustrated herein can be present in a number of effective amounts, such as for example, from about 40 to about 85 weight percent, from about 45 to about 80 weight percent, from about 50 to about 75 weight percent, from about 50 to about 70 weight percent, or from about 55 to about 65 weight percent based on the total charge transport layer solids of the charge transport component, the bio-based polycarbonates, and optional polymers.

The terpene polycarbonates, such as the homopolymers and copolymers thereof, possess, for example, a weight average molecular weight of from about 40,000 to about 70,000 or from about 50,000 to about 60,000 as determined by GPC analysis, and a number average molecular weight of from about 30,000 to about 60,000 or from about 40,000 to about 50,000, as determined by GPC analysis.

Preparation of Bio-Based Terpene Polycarbonates

The bio-based terpene polycarbonates, like the homopolymers and copolymers thereof disclosed herein, can be prepared from or derived from terpenes as illustrated in the article Synthesis of New Bio-based Polycarbonates Derived From Terpene, by Yuanrong Xin and Hiroshi Uyama, received on Aug. 2, 2012, accepted on Oct. 22, 2012, and published online Nov. 8, 2012, (Journal of Polymer Research, 2012), the disclosure of this article being totally incorporated herein by reference. In embodiments, the processes for the preparation of the bio-based terpene polycarbonates disclosed herein involves melt polymerization of monomers, such as terpene diphenol, diphenyl carbonate and/or bisphenol A (BPA), and where the use of toxic phosgene is avoided.

Terpenes are known bio-based compounds generated from, for example, various plants and conifers. One derivative of terpene is a terpene diphenol (TPD) synthesized from monoterpene and phenol, and which can be selected as a monomer for the preparation of the disclosed terpene-based polycarbonates selected as binder resins for the photoconductor charge transport layers illustrated herein.

Terpenes are considered a large and diverse class of organic compounds, produced by a variety of plants, such as evergreen trees like conifers and originating from insects such as termites or swallowtail butterflies. In addition to their roles as end-products in many organisms, terpenes are major biosynthetic building blocks within nearly every living creature.

Terpenes and terpenoids or isoprenoids are the primary constituents of the essential oils of many types of plants and flowers. Essential oils are used widely as natural flavor additives for food, as fragrances in perfumery, and in traditional and alternative medicines such as aromatherapy. Synthetic variations and derivatives of natural terpenes and terpenoids also greatly expand the variety of aromas used in perfumery and flavors used in food additives. Vitamin A is an example of a terpene.

Terpenes are derived biosynthetically from units of isoprene, which has the molecular formula C₅H₈. The basic molecular formulae of terpenes are comprised of multiples of isoprene CH₂═C(CH₃)—CH═CH₂ (C₅H₈)ₙ where n is the number of linked isoprene units. The isoprene units may be linked together “head to tail” to form linear chains or they may be arranged to form rings. Terpene hydrocarbons can be classified according to the number of isoprene units, such as monoterpenes with two isoprene units or segments, sesquiterpenes with three isoprene units or segments, diterpenes with four isoprene units or segments, triterpenes with six isoprene units or segments, and tetraterpenes with eight isoprene units or segments.

Examples of Terpenes are:

Hemiterpenes comprised of a single isoprene unit, and where isoprene itself is considered the only hemiterpene, however, oxygen-containing derivatives, such as prenol and isovaleric acid, can be considered hemiterpenoids.

Monoterpenes comprised of two isoprene units with the molecular formula C₁₀H₁₆, examples of which are geraniol, limonene and terpineol.

Sesquiterpenes comprised of three isoprene units with the molecular formula C₁₅H₂₄, examples of which are humulene, farnesenes, and farnesol.

Diterpenes comprised of four isoprene units with the molecular formula C₂₀H₃₂, derived from geranylgeranyl pyrophosphate. Examples of diterpenes are cafestol, kahweol, cembrene and taxadiene.

Sesterterpenes with, for example, 25 carbons and 5 isoprene units, an example of which is geranylfarnesol.

Triterpenes comprised of six isoprene units and with the molecular formula C₃₀H₄₈. The linear triterpene squalene, the major constituent of shark liver oil, is derived from the reductive coupling of two molecules of farnesyl pyrophosphate. Squalene is then processed biosynthetically to generate either lanosterol or cycloartenol, the structural precursors for steroids.

Sesquarterpenes comprised of seven isoprene units with the molecular formula C₃₅H₅₆, examples of which are ferrugicadiol and tetraprenylcurcumene.

Tetraterpenes comprised of eight isoprene units with the molecular formula C₄₀H₆₄, such as acyclic lycopene, monocyclic gamma-carotene, and bicyclic alpha- and beta-carotenes.

Polyterpenes comprised of long chains of numerous isoprene units, such as natural rubbers and plants that generate polyisoprenes with trans double bonds, known as gutta-percha.

Norisoprenoids, such as the C₁₃-norisoprenoids 3-oxo-α-ionol, present in Muscat of Alexandria leaves and 7,8-dihydroionone derivatives, such as megastigmane-3,9-diol and 3-oxo-7,8-dihydro-α-ionol found in Shiraz leaves and which can be produced by fungal peroxydases or glycosidases.

The bio-based terpene homopolymer polycarbonates can be synthesized in accordance with the Journal of Polymer Research, 2012 article referenced herein, the disclosure of which is totally incorporated herein by reference, and as illustrated in the following reaction scheme

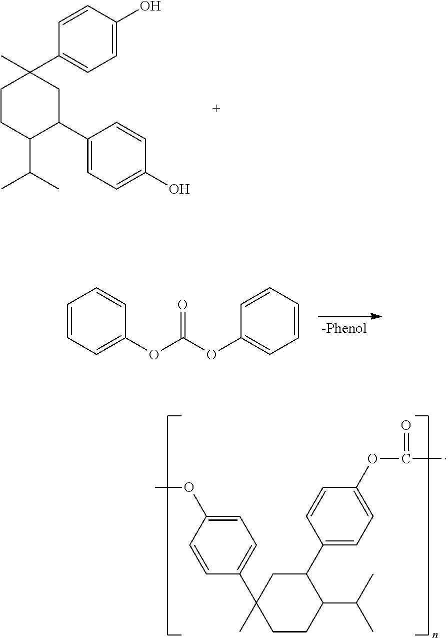

A terpene diphenol/bisphenol A polycarbonate copolymer can be synthesized in accordance with the processes disclosed in the Journal of Polymer Research, 2012, article referenced herein, the disclosure of which is totally incorporated herein by reference and as illustrated in the following reaction scheme

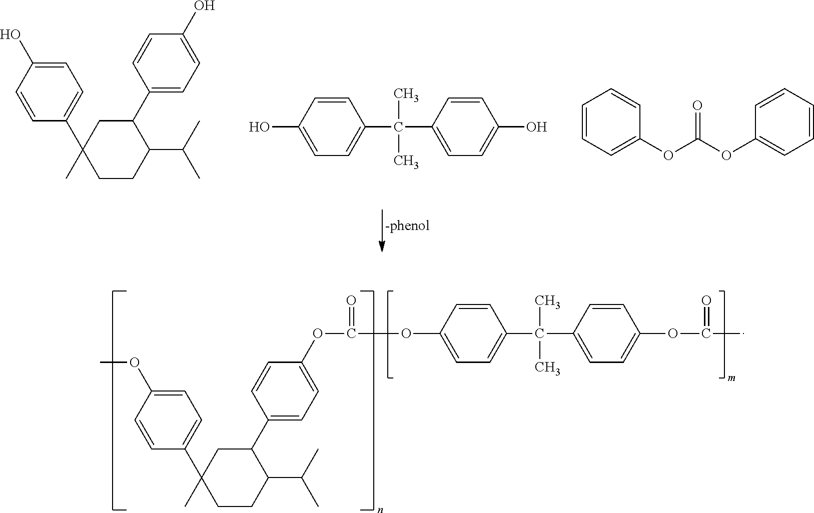

The disclosed terpene diphenol/bisphenol Z polycarbonate copolymer and terpene diphenol/bisphenol C polycarbonate copolymers can be synthesized as described in the referenced Journal of Polymer Research, 2012, article recited herein and as illustrated herein with respect to the terpene diphenol/bisphenol A polycarbonate copolymer.

The reaction parameters, such as monomer feed ratio, polymerization temperature and time, can vary depending, for example, on the amounts of reactants, the terpenes selected, the desired product yields, and the like as illustrated in the article referred to herein. Thus, for example, the disclosed bio-based terpene polycarbonate can be synthesized by the melt polycondensation of terpene diphenol (TPD) and a diphenyl carbonate (DPC) in a mole ratio of, for example, from about 0.80 to about 1.05 or from about 0.90 to about 1. The reaction mixture is heated at a suitable temperature, such as from about 160° C. to about 180° C. or from about 165° C. to about 175° C. for a suitable period of, for example, from about 20 to about 40 minutes, or from about 25 to about 35 minutes under nitrogen or other inert gases, and then retained at a temperature of from about 200° C. to about 260° C. or from about 210° C. to about 250° C. for a period of time of, for example, from about 20 to about 50 minutes, or from about 25 to about 35 minutes, under a nitrogen or other inert gas stream. The pressure present or generated is gradually reduced to from about 5 to about 7 Torr, within a period of, for example, from about 20 to about 40 minutes, and where the resulting reaction mixture is retained at a temperature of from about 210° C. to about 260° C. under vacuum, for a period of from about 1 to about 5 hours at a temperature of from about 210° C. to about 260° C. After cooling to room temperature, about 22° C. to about 27° C., the obtained reaction mixture is dissolved in a solvent like chloroform, methylene chloride, tetrahydrofuran (THF), toluene, monochlorobenzene, or mixtures thereof. The resulting solution is then poured into a 300 milliliter beaker that contains about 225 milliliters of solvent, such as methanol. The precipitates resulting are collected and dried in vacuum at a temperature of from about 50° C. to about 70° C. overnight, from about 12 to about 15 hours, and where the structure of the synthetic terpene polycarbonate can be confirmed by H-NMR.

The terpene diphenol/bisphenol A polycarbonate copolymer is synthesized by the melt polycondensation of a terpene diphenol (TPD)/bisphenol A (BPA) mixture and diphenyl carbonate (DPC) in a mole ratio of, for example, from about 0.80 to about 1.05 or from about 0.90 to about 1. The reaction mixture is heated at a suitable temperature, such as from about 160° C. to about 180° C. or from about 165° C. to about 175° C. for a suitable period of, for example, from about 20 to about 40 minutes, or from about 25 to about 35 minutes under nitrogen or other inert gases, and then retained at a temperature of from about 200° C. to about 260° C. or from about 210° C. to about 250° C. for a period of time of, for example, from about 20 to about 50 minutes, or from about 25 to about 35 minutes, under a nitrogen or other inert gas stream. The pressure present or generated is gradually reduced to from about 5 to about 7 Torr within a period of, for example, from about 20 to about 40 minutes, and where the resulting reaction mixture is retained at a temperature of from about 210° C. to about 260° C. under vacuum, for a period of from about 1 to about 5 hours at a temperature of from about 210° C. to about 260° C. After cooling to room temperature, about 22° C. to about 27° C., the obtained reaction mixture is dissolved in a solvent like chloroform, methylene chloride, tetrahydrofuran (THF), toluene, monochlorobenzene, or mixtures thereof. The resulting solution is then poured into a 300 milliliter beaker that contains about 225 milliliters of solvent, such as methanol. The precipitates resulting are collected and dried in vacuum at a temperature of from about 50° C. to about 70° C. overnight, from about 12 to about 15 hours, and where the structure of the synthetic terpene diphenol/bisphenol A polycarbonate copolymer can be confirmed by ¹H-NMR.

The obtained disclosed terpene polycarbonates like terpene diphenol/bisphenol A polycarbonate copolymers are amorphous and possess an about 5° C. to 95° C., or from about 25° C. to about 75° C. higher glass transition temperature, or T_{g} than a bisphenol A polycarbonate homopolymer, which higher Tg translates into excellent photoconductor wear resistance and environmental acceptability. In addition, both the terpene polycarbonate homopolymer and the terpene diphenol/bisphenol A polycarbonate copolymers are soluble in common organic solvents, such as methylene chloride, THF and toluene, enabling the bio-based polycarbonates to be readily included in a photoconductor by known coating processes.

Similarly, the disclosed terpene diphenol/bisphenol Z polycarbonate copolymers are believed to be amorphous and possess a 10° C. to 70° C. higher T_{g} than the bisphenol Z polycarbonate homopolymer, which translates into excellent photoconductor wear resistance and environmental acceptability, and the disclosed terpene diphenol/bisphenol C polycarbonate copolymers are believed to be amorphous and possess a 10° C. to 70° C. higher T_{g} than the bisphenol C polycarbonate homopolymer, which translates into excellent photoconductor wear resistance and environmental acceptability.

### PHOTOCONDUCTOR LAYER EXAMPLES

A number of known components can be selected for the various photoconductor layers, such as the supporting substrate layer, the photogenerating layer, the charge transport layer mixture, the ground plane layer when present, the hole blocking layer when present, and the adhesive layer when present.

Supporting Substrates

The thickness of the photoconductor supporting substrate layer depends on many factors, including economical considerations, the electrical characteristics desired, adequate flexibility properties, availability, and cost of the specific components for each layer, and the like, thus this layer may be of a substantial thickness, for example about 2,500 microns, such as from about 100 to about 2,000 microns, from about 400 to about 1,000 microns, or from about 200 to about 600 microns (“about” throughout includes all values in between the values recited), or of a minimum thickness. In embodiments, the thickness of this layer is from about 70 to about 300 microns, or from about 100 to about 175 microns.

The photoconductor substrate may be opaque or substantially transparent, and may comprise any suitable material including known or future developed materials. Accordingly, the substrate may comprise a layer of an electrically nonconductive or conductive material, such as an inorganic or an organic composition. As electrically nonconducting materials, there may be employed various resins known for this purpose including polyesters, polycarbonates, polyamides, polyurethanes, and the like, which are flexible as thin webs. An electrically conducting substrate may be any suitable metal of, for example, aluminum, nickel, steel, copper, gold, and the like, or a polymeric material, as described above, filled with an electrically conducting substance, such as carbon, metallic powder, and the like, or an organic electrically conducting material. The electrically insulating or conductive substrate may be in the form of an endless flexible belt, a web, a rigid cylinder, a sheet, and the like. The thickness of the substrate layer depends on numerous factors, including strength desired, and economical considerations. For a drum, this layer may be of a substantial thickness of, for example, up to many centimeters or of a minimum thickness of less than a millimeter. Similarly, a flexible belt may be of a substantial thickness of, for example, about 250 microns, or of a minimum thickness of less than about 50 microns provided there are no adverse effects on the final electrophotographic device.

In embodiments where the substrate layer is not conductive, the surface thereof may be rendered electrically conductive by an electrically conductive coating. The conductive coating may vary in thickness over substantially wide ranges depending upon the optical transparency, degree of flexibility desired, and economic factors.

Illustrative examples of substrates are as illustrated herein, and more specifically, supporting substrate layers selected for the photoconductors of the present disclosure, and which substrates can be opaque or substantially transparent comprise a layer of insulating material including inorganic or organic polymeric materials, such as MYLAR® a commercially available polymer, MYLAR® containing titanium, a layer of an organic or inorganic material having a semiconductive surface layer, such as indium tin oxide, or aluminum arranged thereon, or a conductive material inclusive of aluminum, chromium, nickel, brass, or the like. The substrate may be flexible, seamless, or rigid, and may have a number of many different configurations, such as for example, a plate, a cylindrical drum, a scroll, an endless flexible belt, and the like. In embodiments, the substrate is in the form of a seamless flexible belt. In some situations, it may be desirable to coat on the back of the substrate, particularly when the substrate is a flexible organic polymeric material, an anticurl layer, such as, for example, polycarbonate materials commercially available as MAKROLON®.

Anticurl Layer

In some situations, it may be desirable to coat an anticurl layer on the back of the photoconductor substrate, particularly when the substrate is a flexible organic polymeric material. This anticurl layer, which is sometimes referred to as an anticurl backing layer, minimizes undesirable curling of the substrate. Suitable materials selected for the disclosed photoconductor anticurl layer include, for example, polycarbonates commercially available as MAKROLON®, polyesters, and the like. The anticurl layer can be of a thickness of from about 5 to about 40 microns, from about 10 to about 30 microns, or from about 15 to about 25 microns.

Ground Plane Layer

Positioned on the top side of the supporting substrate, there can be included an optional ground plane such as gold, gold containing compounds, aluminum, titanium, titanium/zirconium, and other suitable known components. The thickness of the ground plane layer can be from about 10 to about 100 nanometers, from about 20 to about 50 nanometers, from about 10 to about 30 nanometers, from about 15 to about 25 nanometers, or from about 20 to about 35 nanometers.

Hole-Blocking Layer

An optional charge blocking layer or hole blocking layer may be applied to the photoconductor supporting substrate, such as to an electrically conductive supporting substrate surface prior to the application of a photogenerating layer. An optional charge blocking layer or hole blocking layer, when present, is usually in contact with the ground plane layer, and also can be in contact with the supporting substrate. The hole blocking layer generally comprises any of a number of known components as illustrated herein, such as metal oxides, phenolic resins, aminosilanes, and the like, and mixtures thereof. The hole blocking layer can have a thickness of from about 0.01 to about 30 microns, from about 0.02 to about 5 microns, or from about 0.03 to about 2 microns.

Examples of aminosilanes included in the hole blocking layer can be represented by the following formulas/structures

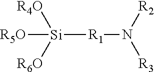

wherein R₁ is alkylene, straight chain, or branched containing, for example, from 1 to about 25 carbon atoms, from 1 to about 18 carbon atoms, from 1 to about 12 carbon atoms, or from 1 to about 6 carbon atoms; R₂ and R₃ are, for example, independently selected from the group consisting of at least one of a hydrogen atom, alkyl containing, for example, from 1 to about 12 carbon atoms, from 1 to about 10 carbon atoms, or from 1 to about 4 carbon atoms; aryl containing, for example, from about 6 to about 24 carbon atoms, from about 6 to about 18 carbon atoms, or from about 6 to about 12 carbon atoms, such as a phenyl group, and a poly(alkylene amino) group, such as a poly(ethylene amino) group, and where R₄, R₅ and R₆ are independently an alkyl group containing, for example, from 1 to about 12 carbon atoms, from 1 to about 10 carbon atoms, or from 1 to about 4 carbon atoms.

Specific examples of suitable hole blocking layer aminosilanes include 3-aminopropyl triethoxysilane, N,N-dimethyl-3-aminopropyl triethoxysilane, N-phenylaminopropyl trimethoxysilane, triethoxysilylpropylethylene diamine, trimethoxysilylpropylethylene diamine, trimethoxysilylpropyldiethylene triamine, N-aminoethyl-3-aminopropyl trimethoxysilane, N-2-aminoethyl-3-aminopropyl trimethoxysilane, N-2-aminoethyl-3-aminopropyl tris(ethylethoxy)silane, p-aminophenyl trimethoxysilane, N,N′-dimethyl-3-aminopropyl triethoxysilane, 3-aminopropyl methyl diethoxysilane, 3-aminopropyl trimethoxysilane, N-methylaminopropyl triethoxysilane, methyl[2-(3-trimethoxysilylpropylamino)ethylamino]-3-proprionate, (N,N′-dimethyl 3-amino)propyl triethoxysilane, N,N-dimethylaminophenyl triethoxysilane, trimethoxysilyl propyldiethylene triamine, and the like, and mixtures thereof. Specific aminosilanes incorporated into the hole blocking layer are 3-aminopropyl triethoxysilane (γ-APS), N-aminoethyl-3-aminopropyl trimethoxysilane, (N,N′-dimethyl-3-amino)propyl triethoxysilane, or mixtures thereof.

The hole blocking layer aminosilane may be treated to form a hydrolyzed silane solution before being added into the final hole blocking layer coating solution or dispersion. During hydrolysis of the aminosilanes, the hydrolyzable groups, such as the alkoxy groups, are replaced with hydroxyl groups. The pH of the hydrolyzed silane solution can be controlled to from about 4 to about 10, or from about 7 to about 8 to thereby result in photoconductor electrical stability. Control of the pH of the hydrolyzed silane solution may be affected with any suitable material, such as generally organic acids or inorganic acids. Examples of organic and inorganic acids selected for pH control include acetic acid, citric acid, formic acid, hydrogen iodide, phosphoric acid, hydrofluorosilicic acid, p-toluene sulfonic acid, and the like.

The hole blocking layer can, in embodiments, be prepared by a number of known methods, the process parameters being dependent, for example, on the photoconductor member desired. The hole blocking layer can be coated as a solution or a dispersion onto the photoconductor supporting substrate, or on to the ground plane layer by the use of a spray coater, a dip coater, an extrusion coater, a roller coater, a wire-bar coater, a slot coater, a doctor blade coater, a gravure coater, and the like, and dried at, for example, from about 40° C. to about 200° C. or from 75° C. to 150° C. for a suitable period of time, such as for example, from about 1 to about 4 hours, from about 1 to about 10 hours, or from about 40 to about 100 minutes in the presence of an air flow. The hole blocking layer coating can be accomplished in a manner to provide a final hole blocking layer thickness after drying of, for example, from about 0.01 to about 30 microns, from about 0.02 to about 5 microns, or from about 0.03 to about 2 microns.

Adhesive Layer

An optional adhesive layer may be included between the photoconductor hole blocking layer and the photogenerating layer. Typical adhesive layer materials selected for the photoconductors illustrated herein, include polyesters, polyurethanes, copolyesters, polyamides, poly(vinyl butyrals), poly(vinyl alcohols), polyacrylonitriles, and the like, and mixtures thereof. The adhesive layer thickness can be, for example, from about 0.001 to about 1 micron, from about 0.05 to about 0.5 micron, or from about 0.1 to about 0.3 micron. Optionally, the adhesive layer may contain effective suitable amounts of from about 1 to about 10 weight percent, or from about 1 to about 5 weight percent of conductive particles, such as zinc oxide, titanium dioxide, silicon nitride, and carbon black, nonconductive particles, such as polyester polymers, and mixtures thereof.

Photogenerating Layer

Usually, the disclosed photoconductor photogenerating layer is applied by vacuum deposition or by spray drying onto the supporting substrate, and a charge transport layer or a plurality, from about 2 to about 6, from 2 to 5, from 2 to 3, or 2 of charge transport layers are formed on the photogenerating layer. The charge transport layer may be situated on the photogenerating layer, the photogenerating layer may be situated on the charge transport layer, or when more than one charge transport layer is present, they can be contained on the photogenerating layer. Also, the photogenerating layer may be applied to any of the layers that are situated between the supporting substrate and the charge transport layer.

Generally, the photogenerating layer can contain known photogenerating pigments, such as metal phthalocyanines, metal free phthalocyanines, alkylhydroxyl gallium phthalocyanines, hydroxygallium phthalocyanines, halogallium phthalocyanines, such as chlorogallium phthalocyanines, perylenes, such as bis(benzimidazo)perylene, titanyl phthalocyanines, especially Type V titanyl phthalocyanine, and the like, and mixtures thereof.

Examples of photogenerating pigments included in the photogenerating layer are vanadyl phthalocyanines, hydroxygallium phthalocyanines, such as Type V hydroxygallium phthalocyanines, high sensitivity titanyl phthalocyanines, Type IV and V titanyl phthalocyanines, quinacridones, polycyclic pigments, such as dibromo anthanthrone pigments, perinone diamines, polynuclear aromatic quinones, azo pigments including bis-, tris- and tetrakis-azos, and the like, and other known photogenerating pigments; inorganic components, such as selenium, selenium alloys, and trigonal selenium; and pigments of crystalline selenium and its alloys.

The photogenerating pigment can be dispersed in a resin binder or alternatively no resin binder need be present. For example, the photogenerating pigments can be present in an optional resinous binder composition in various amounts inclusive of up to from about 99.5 to about 100 weight percent by weight based on the total solids of the photogenerating layer. Generally, from about 5 to about 95 percent by volume of the photogenerating pigment is dispersed in about 95 to about 5 percent by volume of a resinous binder, or from about 20 to about 30 percent by volume of the photogenerating pigment is dispersed in about 70 to about 80 percent by volume of the resinous binder composition. In one embodiment, about 90 percent by volume of the photogenerating pigment is dispersed in about 10 percent by volume of the resinous binder composition.

Examples of polymeric binder materials that can be selected as the matrix or binder for the disclosed photogenerating layer pigments include thermoplastic and thermosetting resins, such as polycarbonates, polyesters, polyamides, polyurethanes, polystyrenes, polyarylethers, polyarylsulfones, polybutadienes, polysulfones, polyethersulfones, polyethylenes, polypropylenes, polymethylpentenes, poly(phenylene sulfides), poly(vinyl acetate), polysiloxanes, polyacrylates, polyvinyl acetals, polyamides, amino resins, phenylene oxide resins, terephthalic acid resins, phenoxy resins, epoxy resins, phenolic resins, acrylonitrile copolymers, poly(vinyl chloride), vinyl chloride and vinyl acetate copolymers, acrylate copolymers, alkyd resins, cellulosic film formers, poly(amideimide), styrene butadiene copolymers, vinylidene chloride-vinyl chloride copolymers, vinyl acetate-vinylidene chloride copolymers, styrene-alkyd resins, poly(vinyl carbazole), and the like, inclusive of block, random, or alternating copolymers thereof.

It is often desirable to select a coating solvent for the disclosed photogenerating layer mixture, and which solvent does not substantially disturb or adversely affect the previously coated layers of the photoconductor. Examples of coating solvents used for the photogenerating layer coating mixture include ketones, alcohols, aromatic hydrocarbons, halogenated aliphatic hydrocarbons, ethers, amines, amides, esters, and the like, and mixtures thereof. Specific solvent examples selected for the photogenerating mixture are cyclohexanone, acetone, methyl ethyl ketone, methanol, ethanol, butanol, amyl alcohol, toluene, xylene, chlorobenzene, carbon tetrachloride, chloroform, methylene chloride, trichloroethylene, tetrahydrofuran, dioxane, diethyl ether, dimethyl formamide, dimethyl acetamide, butyl acetate, ethyl acetate, methoxyethyl acetate, and the like.

The photogenerating layer can be of a thickness of from about 0.01 to about 10 microns, from about 0.05 to about 10 microns, from about 0.2 to about 2 microns, or from about 0.25 to about 1 micron.

Charge Transport Layer

The disclosed charge transport layer or layers, and more specifically, in embodiments, a first or bottom charge transport layer in contact with the photogenerating layer, and included over the first or bottom charge transport layer a top or second charge transport overcoating layer, comprising charge transporting compounds or molecules dissolved, or molecularly dispersed in a film forming electrically inert polymer such as a polycarbonate. In embodiments, “dissolved” refers, for example, to forming a solution in which the charge transport molecules are dissolved in a polymer to form a homogeneous phase; and molecularly dispersed refers, for example, to charge transporting molecules or compounds dispersed on a molecular scale in a polymer.

In embodiments, charge transport refers, for example, to charge transporting molecules that allows the free charges generated in the photogenerating layer to be transported across the charge transport layer. The charge transport layer is usually substantially nonabsorbing to visible light or radiation in the region of intended use, but is electrically active in that it allows the injection of photogenerated holes from the photoconductive layer, or photogenerating layer, and permits these holes to be transported to selectively discharge surface charges present on the surface of the photoconductor.

A number of charge transport compounds or polymers can be included in the terpene polycarbonate charge transport layer mixture or in at least one charge transport layer where at least one charge transport layer is from 1 to about 4 layers, from 1 to about 3 layers, 2 layers, or 1 layer. Examples of charge transport components or compounds present in an amount of from about 15 to about 50 weight percent, from about 35 to about 45 weight percent, or from about 40 to about 45 weight percent based on the total solids of the at least one charge transport layer are the compounds as illustrated in Xerox Corporation U.S. Pat. No. 7,166,397, the disclosure of which is totally incorporated herein by reference, and more specifically, aryl amine compounds or molecules selected from the group consisting of those represented by the following formulas/structures

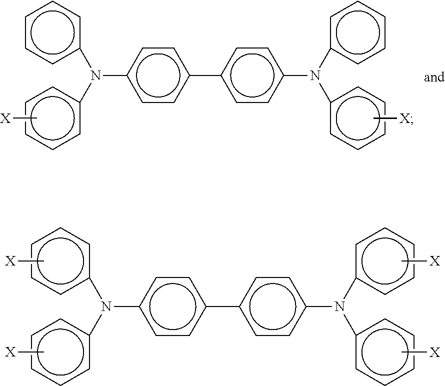

wherein X is a suitable hydrocarbon like alkyl, alkoxy, aryl, isomers thereof, and derivatives thereof like alkylaryl, alkoxyaryl, arylalkyl; a halogen, or mixtures of a suitable hydrocarbon and a halogen; and charge transport layer compounds as represented by the following formula/structure

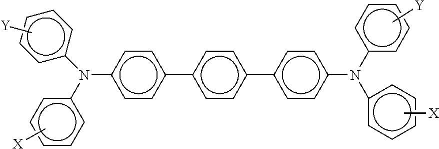

wherein X and Y are independently alkyl, alkoxy, aryl, a halogen, or mixtures thereof.

Alkyl and alkoxy for the photoconductor charge transport layer compounds illustrated herein contain, for example, from about 1 to about 25 carbon atoms, from about 1 to about 12 carbon atoms, or from about 1 to about 6 carbon atoms, such as methyl, ethyl, propyl, butyl, pentyl, hexyl, heptyl, octyl, nonyl, decyl, undecyl, dodecyl, pentadecyl, and the like, and the corresponding alkoxides. Aryl substituents for the charge transport layer compounds can contain from 6 to about 36, from 6 to about 24, from 6 to about 18, or from 6 to about 12 carbon atoms, such as phenyl, naphthyl, anthryl, and the like. Halogen substituents for the charge transport layer compounds include chloride, bromide, iodide, and fluoride. Substituted alkyls, substituted alkoxys, and substituted aryls can also be selected for the disclosed charge transport layer compounds.

Examples of specific aryl amines present in at least one photoconductor charge transport layer include N,N,N′,N′-tetra-p-tolyl-1,1′-biphenyl-4,4′-diamine, N,N′-diphenyl-N,N′-bis(alkylphenyl)-1,1′-biphenyl-4,4′-diamine wherein alkyl is selected from the group consisting of methyl, ethyl, propyl, butyl, hexyl, heptyl, octyl, nonyl, decyl, undecyl, dodecyl, pentadecyl, and the like, N,N′-diphenyl-N,N′-bis(halophenyl)-1,1′-biphenyl-4,4′-diamine wherein the halo substituent is chloro, N,N′-bis(4-butylphenyl)-N,N′-di-p-tolyl-[p-terphenyl]-4,4′-diamine, N,N′-bis(4-butylphenyl)-N,N′-di-m-tolyl-[p-terphenyl]-4,4′-diamine, N,N′-bis(4-butylphenyl)-N,N′-di-o-tolyl-[p-terphenyl]-4,4′-diamine, N,N′-bis(4-butylphenyl)-N,N′-bis-(4-isopropylphenyl)-[p-terphenyl]-4,4′-diamine, N,N′-bis(4-butylphenyl)-N,N′-bis-(2-ethyl-6-methylphenyl)-[p-terphenyl]-4,4′-diamine, N,N′-bis(4-butylphenyl)-N,N′-bis-(2,5-dimethylphenyl)-[p-terphenyl]-4,4′-diamine, N,N′-diphenyl-N,N′-bis(3-chlorophenyl)-[p-terphenyl]-4,4′-diamine, and the like, hydrazones such as N-phenyl-N-methyl-3-(9-ethyl)carbazyl hydrazone and 4-diethyl amino benzaldehyde-1,2-diphenyl hydrazine, or oxadiazoles, such as 2,5-bis(4-N,N′-diethylaminophenyl)-1,2,4-oxadiazole, stilbenes, and the like.

Various processes may be used to mix, and thereafter, apply the charge transport layer or layers coating mixture to the photogenerating layer. Typical charge transport layer application techniques include spraying, dip coating, roll coating, wire wound rod coating, and the like. Drying of the deposited charge transport layer coating or plurality of coatings may be affected by any suitable conventional technique such as oven drying, infrared radiation drying, air drying, and the like.

The thickness of the charge transport layer or charge transport layers, in embodiments, is from about 5 to about 70 microns, from about 20 to about 65 microns, from about 15 to about 50 microns, or from about 10 to about 40 microns, but thicknesses outside this range may, in embodiments, also be selected. The charge transport layer should be an insulator to the extent that an electrostatic charge placed on the charge transport layer is not conducted in the absence of illumination at a rate sufficient to prevent formation and retention of an electrostatic latent image thereon. In general, the ratio of the thickness of the charge transport layer to the photogenerating layer can be from about 2:1 to 200:1, and in some instances about 400:1.

Examples of optional second binders, in addition to the bio-based polycarbonates to, for example, permit enhanced miscibility with the hole transport component selected for the disclosed photoconductor charge transport layers, include polycarbonates, polyarylates, acrylate polymers, vinyl polymers, cellulose polymers, polyesters, polysiloxanes, polyamides, polyurethanes, poly(cyclo olefins), epoxies, and random or alternating copolymers thereof, and more specifically, polycarbonates such as poly(4,4′-isopropylidene-diphenylene) carbonate (also referred to as bisphenol-A-polycarbonate), poly(4,4′-cyclohexylidine diphenylene) carbonate (also referred to as bisphenol-Z-polycarbonate), poly(4,4′-isopropylidene-3,3′-dimethyl-diphenyl) carbonate (also referred to as bisphenol-C-polycarbonate), and the like. In embodiments, electrically inactive second resin binders are comprised of polycarbonate resins with a weight average molecular weight of from about 20,000 to about 100,000, or with a weight average molecular weight M, of from about 50,000 to about 80,000. Generally, the transport layer contains from about 10 to about 75 percent by weight of the charge transport material, and more specifically, from about 35 to about 50 percent of this material.

In embodiments, the charge transport compound can be represented by the following formulas/structures

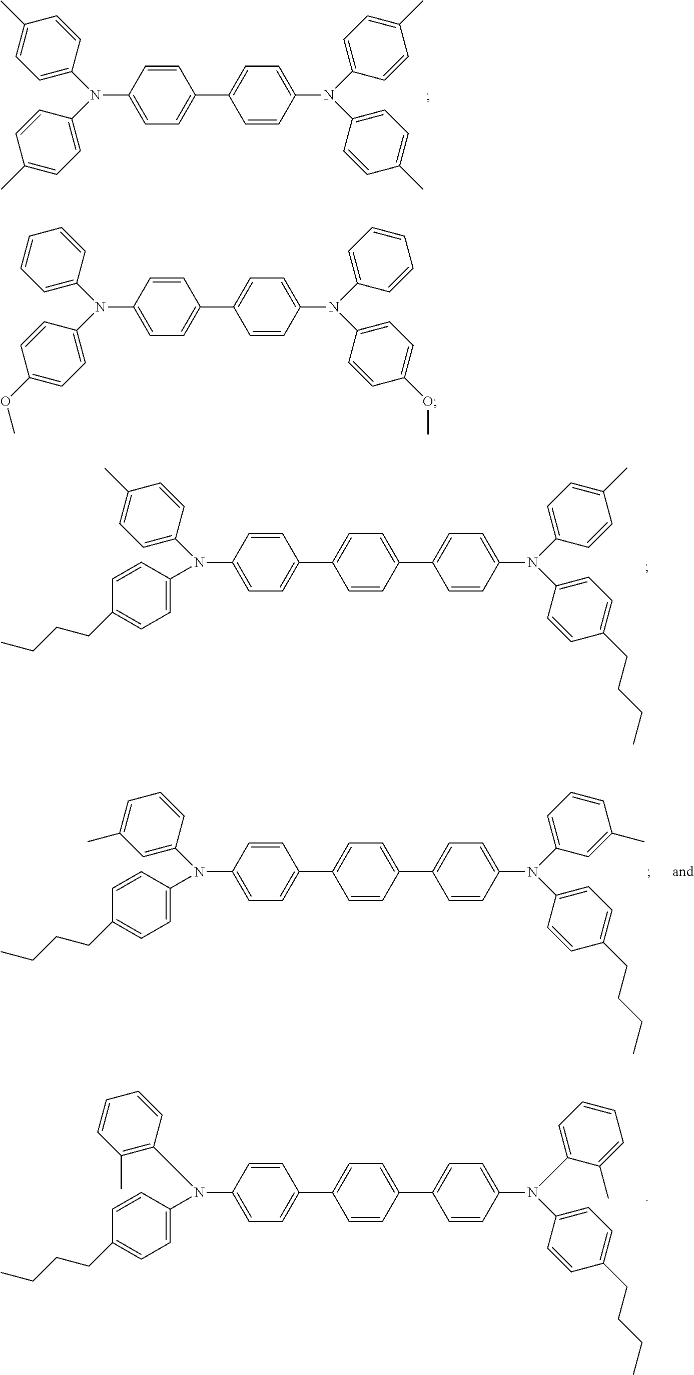

Examples of components or materials optionally incorporated into at least one charge transport layer to, for example, enable excellent lateral charge migration (LCM) resistance include hindered phenolic antioxidants, such as tetrakis methylene(3,5-di-tert-butyl-4-hydroxy hydrocinnamate) methane (IRGANOX™ 1010, available from Ciba Specialty Chemical), butylated hydroxytoluene (BHT), and other hindered phenolic antioxidants including SUMILIZER™ BHT-R, MDP-S, BBM-S, WX-R, NW, BP-76, BP-101, GA-80, GM and GS (available from Sumitomo Chemical Co., Ltd.), IRGANOX™ 1035, 1076, 1098, 1135, 1141, 1222, 1330, 1425WL, 1520L, 245, 259, 3114, 3790, 5057 and 565 (available from Ciba Specialties Chemicals), and ADEKA STAB™ AO-20, AO-30, AO-40, AO-50, AO-60, AO-70, AO-80 and AO-330 (available from Asahi Denka Co., Ltd.); hindered amine antioxidants such as SANOL™ LS-2626, LS-765, LS-770 and LS-744 (available from SNKYO CO., Ltd.), TINUVIN™ 144 and 622LD (available from Ciba Specialties Chemicals), MARK™ LA57, LA67, LA62, LA68 and LA63 (available from Asahi Denka Co., Ltd.), and SUMILIZER™ TPS (available from Sumitomo Chemical Co., Ltd.); thioether antioxidants such as SUMILIZER™ TP-D (available from Sumitomo Chemical Co., Ltd); phosphite antioxidants such as MARK™ 2112, PEP-8, PEP-24G, PEP-36, 329K and HP-10 (available from Asahi Denka Co., Ltd.); other molecules such as bis(4-diethylamino-2-methylphenyl)phenylmethane (BDETPM), bis-[2-methyl-4-(N-2-hydroxyethyl-N-ethyl-aminophenyl)]phenylmethane (DHTPM), and the like. The weight percent of the antioxidant in at least one of the charge transport layers is from about 0 to about 20 weight percent, from about 1 to about 10 weight percent, or from about 3 to about 8 weight percent.

The photoconductor wear rates when selecting for the charge transport layer a mixture of a charge transport compound and the bio-based polycarbonates illustrated herein is, for example, from about 10 to about 70 percent, and more specifically, from about 20 to about 40 percent as compared to a similar known photoconductor that is free of the charge transport layer terpene polycarbonate. Thus, the terpene polycarbonate containing photoconductor wear rate, measurable using an in-house known wear fixture as illustrated herein can be, it is believed, from about 30 to about 70 nanometers/kilocycle, from about 35 to about 65 nanometers/kilocycle, or from about 40 to about 60 nanometers/kilocycle.

In addition to improved wear characteristics, it is believed that the disclosed photoconductors could have color print stability and excellent cyclic stability of almost no or a minimal change in a generated known photoinduced discharge curve (PIDC), especially no or minimal residual potential cycle up after a number of charge/discharge cycles of the photoconductor, for example, about 100 kilocycles, or xerographic prints of, for example, from about 80 to about 100 kilo prints. Color print stability refers, for example, to substantially no or minimal change in solid area density, especially in 60 percent halftone prints, and no or minimal random color variability from print to print after a number of xerographic prints, for example 50 kilo prints.

Also included within the scope of the present disclosure are methods of imaging and printing with the photoconductor devices illustrated herein. These methods generally involve the formation of an electrostatic latent image on the imaging member, followed by developing the image with a toner composition comprised, for example, of a thermoplastic resin, a colorant, such as a pigment, dye, or mixtures thereof, a charge additive, internal additives like waxes, and surface additives, such as for example, silica, coated silica, aminosilane, and the like, reference U.S. Pat. Nos. 4,560,635 and 4,338,390, the disclosures of each of these patents being totally incorporated herein by reference, subsequently transferring the toner image to a suitable image receiving substrate, and permanently affixing the image thereto. In those environments wherein the photoconductor is to be used in a printing mode, the imaging method involves the same operation with the exception that exposure can be accomplished with a laser device or image bar. More specifically, the flexible photoconductor belts disclosed herein can be selected for the Xerox Corporation iGEN® machines that generate with some versions over 110 copies per minute. Processes of imaging, especially xerographic imaging and printing, including digital and/or color printing, are thus encompassed by the present disclosure.

The imaging members or photoconductors illustrated herein are, in embodiments, sensitive in the wavelength region of, for example, from about 400 to about 900 nanometers, and in particular from about 650 to about 850 nanometers, thus diode lasers can be selected as the light source. Moreover, the imaging members of this disclosure are useful in color xerographic applications, particularly high-speed, for example at least 100 copies per minute, color copying and printing processes.

The following Examples are being submitted to illustrate embodiments of the present disclosure. Molecular weights can be determined by Gel Permeation analysis (GPC), and the ratios recited may be determined primarily by the amount of components selected for the preparations indicated.

### Example 1

An undercoat layer is prepared, and then deposited on a 30 millimeter thick aluminum drum substrate as follows.

Zirconium acetylacetonate tributoxide (35.5 parts), γ-aminopropyl triethoxysilane (4.8 parts), and poly(vinyl butyral) BM-S (2.5 parts) are dissolved in n-butanol (52.2 parts). The resulting solution is then coated by a dip coater on the above 30 millimeter thick aluminum drum substrate, and the coating solution layer is pre-heated at 59° C. for 13 minutes, humidified at 58° C. (dew point=54° C.) for 17 minutes, and dried at 135° C. for 8 minutes. The thickness of the resulting undercoat layer is approximately 1.3 microns.

A photogenerating layer, 0.2 micron in thickness, comprising chlorogallium phthalocyanine (Type C) is deposited on the above undercoat layer. The photogenerating layer coating dispersion is prepared as follows. 2.7 Grams of chlorogallium phthalocyanine (ClGaPc) Type C pigment is mixed with 2.3 grams of the polymeric binder (carboxyl-modified vinyl copolymer, VMCH, available from Dow Chemical Company, 15 grams of n-butyl acetate, and 30 grams of xylene. The resulting mixture is mixed in an Attritor mill with about 200 grams of 1 millimeter Hi-Bea borosilicate glass beads for about 3 hours. The dispersion mixture obtained is then filtered through a 20 micron Nylon cloth filter, and the solids content of the dispersion is diluted to about 6 weight percent.

Subsequently, a 32 micron charge transport layer is coated on top of the above photogenerating layer from a solution prepared from a mixture of N,N′-diphenyl-N,N-bis(3-methylphenyl)-1,1′-biphenyl-4,4′-diamine (mTBD), 39.6 weight percent, and 59.4 weight percent of the biodegradable or bio-based terpene polycarbonate homopolymer of the following formula/structure

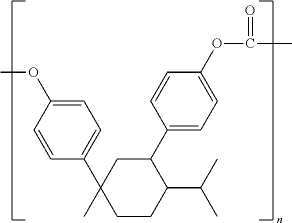

where n is 100 mole percent, dissolved in a solvent mixture of tetrahydrofuran/toluene 70/30, followed by drying in an oven at about 120° C. for about 40 minutes. The obtainable 32 micron thick charge transport layer is believed to be comprised of the bio-based terpene polycarbonate/mTBD in a 59.4/40.6 ratio.

### Example 2

A photoconductor is prepared by repeating the process of Example 1 except that there is selected for the 32 micron thick charge transport layer in place of the terpene polycarbonate homopolymer, a terpene polycarbonate copolymer of the following formula/structure

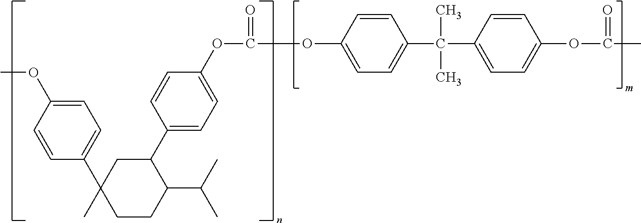

where m is 65 mole percent and n is 35 mole percent, and the sum of m plus n is equal to about 100 mole percent.

### Example 3

A photoconductor is prepared by repeating the process of Example 1 except that there is selected for the 32 micron thick charge transport layer in place of the terpene polycarbonate homopolymer, a terpene polycarbonate copolymer of the following formula/structure

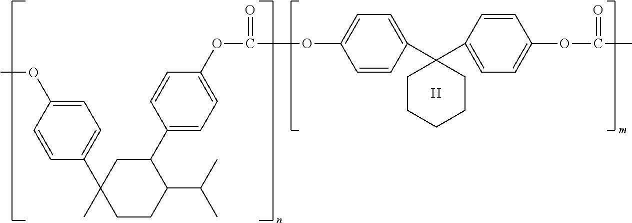

where m is 50 mole percent and n is 50 mole percent, and the sum of m plus n is equal to about 100 mole percent.

### Example 4

A photoconductor is prepared by repeating the process of Example 1 except that there is selected for the 32 micron thick charge transport layer in place of the terpene polycarbonate homopolymer, a terpene polycarbonate copolymer of the following formula/structure

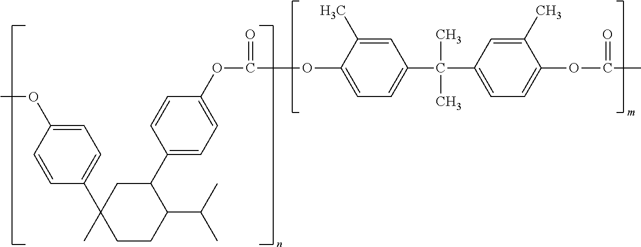

where m is 80 mole percent and n is 20 mole percent, and the sum of m plus n is equal to about 100 mole percent.

It is believed that subjecting the above photoconductors of Examples 1, 2, and 3 to known photoconductor testing should result in acceptable electrical properties and excellent wear resistance characteristics.

### Electrical Property Testing

The above prepared photoconductors of Example 1, Example 2, and Example 3 may be tested in a scanner set to obtain photoinduced discharge cycles, sequenced at one charge-erase cycle followed by one charge-expose-erase cycle, wherein the light intensity is incrementally increased with cycling to obtain a series of photoinduced discharge characteristic curves from which the photosensitivity and surface potentials at various exposure intensities can be measured. Additional electrical characteristics may be obtained by a series of charge-erase cycles with incrementing surface potential to generate several voltages versus charge density curves. The scanner is equipped with a scorotron set to a constant voltage charging at various surface potentials. The above photoconductors can be tested at surface potentials of 700 volts with the exposure light intensity incrementally increased by means of regulating a series of neutral density filters; and the exposure light source is a 780 nanometer light emitting diode. The xerographic simulation is completed in an environmentally controlled light tight chamber at ambient conditions (40 percent relative humidity and 22° C.).

Substantially similar excellent PIDCs are believed to be obtainable for the above three photoconductors, therefore, the incorporation of the terpene polycarbonates of Examples 1, 2, and 3 should not adversely affect the electrical properties of these photoconductors.

### Wear Testing

Wear tests of the photoconductors of Examples 1, 2, and 3 might be performed using an in house wear test fixture (biased charging roll and BCR charging with peak to peak voltage of 1.8 kilovolts). The total thickness of each photoconductor is measured via Permascope before each wear test is initiated. Then the photoconductors are separately placed into the wear fixture for 100 kilocycles. The total photoconductor thickness is measured again with the Permascope, and the difference in thickness is used to calculate the wear rate (nanometers/kilocycle) of the photoconductors. The smaller the wear rate, the more wear resistant is the photoconductor.

It is believed that the wear rates of the Examples 1, 2, and 3 photoconductors would be from about 40 to about 60 nanometers/kilocycle versus a high unacceptable wear rate of about 90 nanometers/kilocycle for a photoconductor that does not include the bio-based polycarbonates.

Thus, it is expected, in accordance with the principles of the teachings of the present disclosure, that photoconductors possessing wear rates of from about to about 75 nanometers/kilocycle, or from about 40 to about 60 nanometers/kilocycle, or better are achievable.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

1. A photoconductor consisting of an optional supporting substrate, a photogenerating layer, and a charge transport layer, and wherein said charge transport layer contains a charge transport component and a biodegradable or bio-based terpene polycarbonate selected from the group consisting of those represented by the following formulas/structures and mixtures thereof 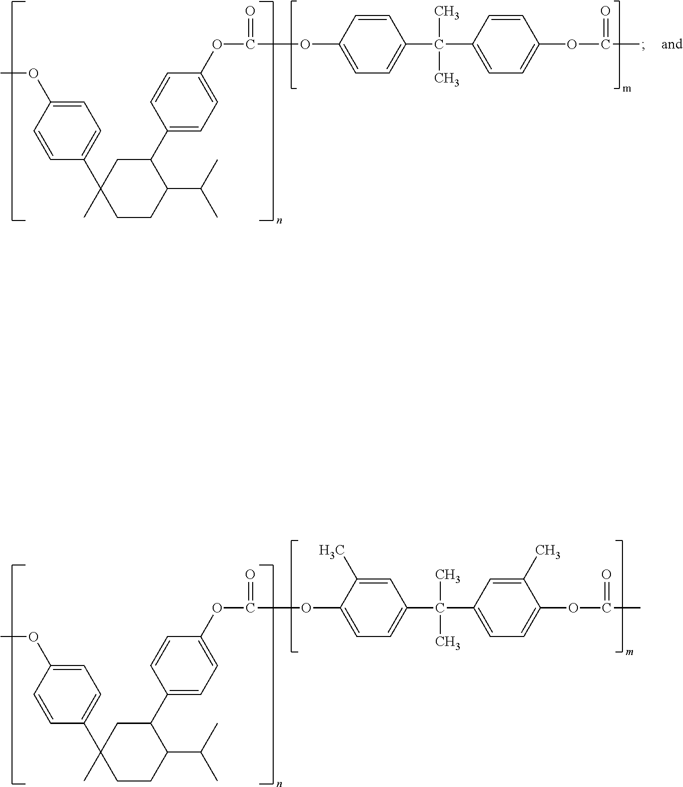
wherein m and n represent the mole percents of each segment, wherein m is from about 1 to about 99 mole percent, and n is from about 99 to about 1 mole percent, and wherein the total thereof is about 100 mole percent.

2. (canceled)

3. (canceled)

4. A photoconductor in accordance with claim 1 wherein for said terpene copolymers m is from about 35 to about 75 mole percent, and n is from about 25 to about 65 mole percent.

5. A photoconductor in accordance with claim 1 wherein said terpene polycarbonate is represented by the following formulas/structures 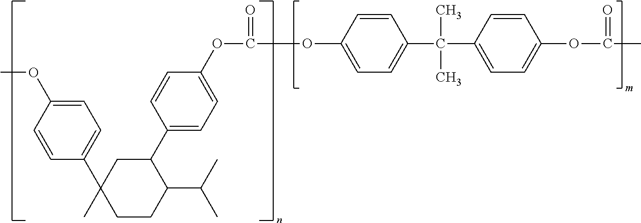
wherein m is from about 45 to about 90 mole percent and n is from about 10 to about 55 mole percent, and wherein the total thereof is about 100 mole percent and wherein said terpene polycarbonate is generated from the reaction of a copolymer of terpene polycarbonate and poly(4,4′-isopropylidene-diphenylene)carbonate or polycarbonate A.

6. A photoconductor in accordance with claim 1 wherein said terpene polycarbonate copolymer is represented by the following formulas/structures 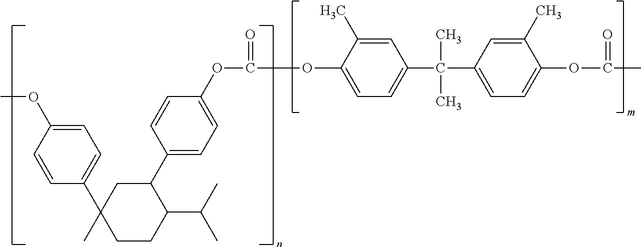
m is from about 35 to about 85 mole percent, and n is from about 15 to about 65 mole percent and wherein said terpene polycarbonate is formed from the reaction of a terpene polycarbonate and poly(4,4′-isopropylidene-3,3′-dimethyl-diphenylene)carbonate or polycarbonate C.

7. A photoconductor in accordance with claim 1 wherein said terpene polycarbonate is biodegradable.

8. (canceled)

9. A photoconductor in accordance with claim 1 wherein said terpene polycarbonate is present in an amount of from about 35 to about 80 weight percent.

10. A photoconductor in accordance with claim 9 wherein said terpene polycarbonate is present in an amount of from about 50 to about 70 weight percent based on the solids thereof.

11. (canceled)

12. (canceled)

13. A photoconductor in accordance with claim 1 wherein said charge transport component is selected from the group consisting of N,N′-bis(methylphenyl)-1,1-biphenyl-4,4′-diamine, tetra-p-tolyl-biphenyl-4,4′-diamine, N,N′-diphenyl-N,N′-bis(4-methoxyphenyl)-1,1-biphenyl-4,4′-diamine, N,N′-bis(4-butylphenyl)-N,N′-di-p-tolyl-[p-terphenyl]-4,4′-diamine, N,N′-bis(4-butylphenyl)-N,N′-di-m-tolyl-[p-terphenyl]-4,4′-diamine, N,N′-bis(4-butylphenyl)-N,N′-di-o-tolyl-[p-terphenyl]-4,4′-diamine, N,N′-bis(4-butylphenyl)-N,N′-bis-(4-isopropylphenyl)-[p-terphenyl]-4,4′-diamine, N,N′-bis(4-butylphenyl)-N,N′-bis-(2-ethyl-6-methylphenyl)-[p-terphenyl]-4,4′-diamine, N,N′-bis(4-butylphenyl)-N,N′-bis-(2,5-dimethylphenyl)-[p-terphenyl]-4,4′-diamine, and N,N′-diphenyl-N,N′-bis(3-chlorophenyl)-[p-terphenyl]-4,4′-diamine.

14. A photoconductor in accordance with claim 1 wherein said photogenerating layer consists of at least one photogenerating pigment.

15. A photoconductor in accordance with claim 1 wherein said photogenerating layer consists of at least one of a titanyl phthalocyanine, a hydroxygallium phthalocyanine, a halogallium phthalocyanine, a bisperylene, and mixtures thereof.

16. (canceled)

17. (canceled)

18. (canceled)

19. A photoconductor consisting of and in sequence a supporting substrate, a hole blocking layer thereover, a photogenerating layer, and a hole transport layer consisting of a mixture of a hole transport compound and a bio-based terpene polycarbonate, selected from the group consisting of those represented by the following formulas/structures and mixtures thereof 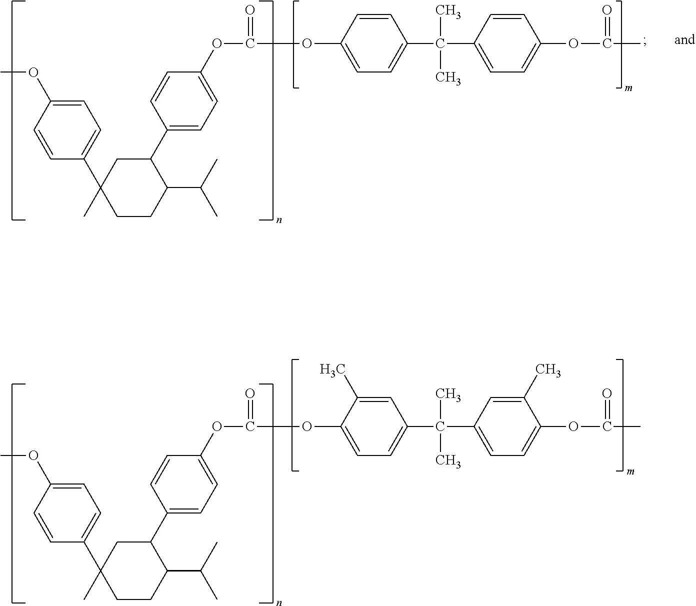
wherein m is from about 35 to about 85 mole percent, and n is from about 15 to about 65 mole percent and wherein the total thereof is about 100 mole percent.

20. A photoconductor in accordance with claim 19 wherein said polycarbonate is represented by the following formulas/structures [chemical structure]
